(19) United States
(12) Patent Application Publication
(10) Pub. No.: US 2023/0029335 A1
(43) Pub. Date: Jan. 26, 2023

(54) SYSTEM AND METHOD OF CONVOLUTIONAL NEURAL NETWORK

(71) Applicants: TAIWAN SEMICONDUCTOR MANUFACTURING COMPANY, LTD., Hsinchu (TW); NATIONAL TSING HUA UNIVERSITY, Hsinchu City (TW)

(72) Inventors: Chao-Tsung HUANG, Hsinchu City (TW); Hsiu-Pin HSU, New Taipei City (TW)

(73) Assignees: TAIWAN SEMICONDUCTOR MANUFACTURING COMPANY, LTD., Hsinchu (TW); NATIONAL TSING HUA UNIVERSITY, Hsinchu City (TW)

(21) Appl. No.: 17/493,661

(22) Filed: Oct. 4, 2021

Related U.S. Application Data
(60) Provisional application No. 63/224,995, filed on Jul. 23, 2021.

(51) Int. Cl. G06T 3/40; G06T 1/00; G06K 9/46; G06K 9/00; G06T 1/60; G06N 3/04

(52) U.S. Cl. CPC G06T 3/4046; G06T 1/0007; G06K 9/46; G06K 9/00979; G06T 1/60; G06N 3/0454

(57) ABSTRACT

A method the following operations: downscaling an input image to generate a scaled image; performing, to the scaled image, a first convolutional neural networks (CNN) modeling process with first non-local operations, to generate global parameters; and performing, to the input image, a second CNN modeling process with second non-local operations that are performed with the global parameters, to generate an output image corresponding to the input image. A system is also disclosed herein.

### PRIORITY CLAIM AND CROSS-REFERENCE

This application claims priority to U.S. Provisional Application No. 63/224,995, filed on Jul. 23, 2021, the entirety of which is herein incorporated by reference.

### BACKGROUND

A convolutional neural network (CNN) operation processes an input image to generate an output image. A block-based CNN operation processes image blocks of the input image to generate image blocks of the output image. However, when an image block is processed, global information of the whole input image is not involved. As a result, the image blocks generated by the block-based CNN operation are lack of the global information.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a process of a convolutional neural network (CNN) system processing an input image in accordance with some embodiments of the present disclosure.

FIG. 2A is a schematic diagram of a CNN process with block-based flow, corresponding to the sub process as shown in FIG. 1, in accordance with some embodiments of the present disclosure.

FIG. 2B is a schematic diagram of further details of performing the on-chip calculation 220 for CNN operations with block-based flow, in accordance with some embodiments of the present disclosure.

FIG. 3 is a schematic diagram of processing a non-local operation to a feature map, corresponding to the operation as shown in FIG. 1 in accordance with some embodiments of the present disclosure.

FIG. 4A is a flowchart of a method, corresponding to the process as shown in FIG. 1, of a CNN system processing an image in accordance with some embodiments of the present disclosure.

FIG. 4B is a flowchart of a method, corresponding to the process as shown in FIG. 1, of a CNN system processing the image in accordance with some embodiments of the present disclosure.

FIG. 5 is a schematic diagram of a system performing a CNN modeling process, corresponding to the process as shown in FIG. 1, in accordance with some embodiments of the present disclosure.

FIG. 6 is a flowchart of a method of the CNN system shown in FIG. 5 processing an input image to generate an output image in accordance with some embodiments of the present disclosure.

FIG. 7 is a schematic diagram of a system, corresponding to the system as shown in FIG. 5, performing a CNN modeling process, in accordance with some embodiments of the present disclosure.

FIG. 8 is a flowchart of a method of a CNN system as shown in FIG. 7 for processing an input image to generate an output image in accordance with some embodiments of the present disclosure.

FIG. 9A is schematic diagrams of a system, corresponding to the system as shown in FIG. 5, performing a CNN modeling process, in accordance with some embodiments of the present disclosure.

FIG. 9B is schematic diagrams of a system, corresponding to the system as shown in FIG. 5, performing a CNN modeling process, in accordance with some embodiments of the present disclosure.

FIG. 9C is schematic diagrams of a system, corresponding to the system as shown in FIG. 5, performing a CNN modeling process, in accordance with some embodiments of the present disclosure.

### DETAILED DESCRIPTION

The following disclosure provides many different embodiments, or examples, for implementing different features of the provided subject matter. Specific examples of components, materials, values, steps, arrangements or the like are described below to simplify the present disclosure. These are, of course, merely examples and are not intended to be limiting. Other components, materials, values, steps, arrangements or the like are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly. The term mask, photolithographic mask, photomask and reticle are used to refer to the same item.

The terms applied throughout the following descriptions and claims generally have their ordinary meanings clearly established in the art or in the specific context where each term is used. Those of ordinary skill in the art will appreciate that a component or process may be referred to by different names. Numerous different embodiments detailed in this specification are illustrative only, and in no way limits the scope and spirit of the disclosure or of any exemplified term.

It is worth noting that the terms such as “first” and “second” used herein to describe various elements or processes aim to distinguish one element or process from another. However, the elements, processes and the sequences thereof should not be limited by these terms. For example, a first element could be termed as a second element, and a second element could be similarly termed as a first element without departing from the scope of the present disclosure.

In the following discussion and in the claims, the terms “comprising,” “including,” “containing,” “having,” “involving,” and the like are to be understood to be open-ended, that is, to be construed as including but not limited to. As used herein, instead of being mutually exclusive, the term “and/or” includes any of the associated listed items and all combinations of one or more of the associated listed items.

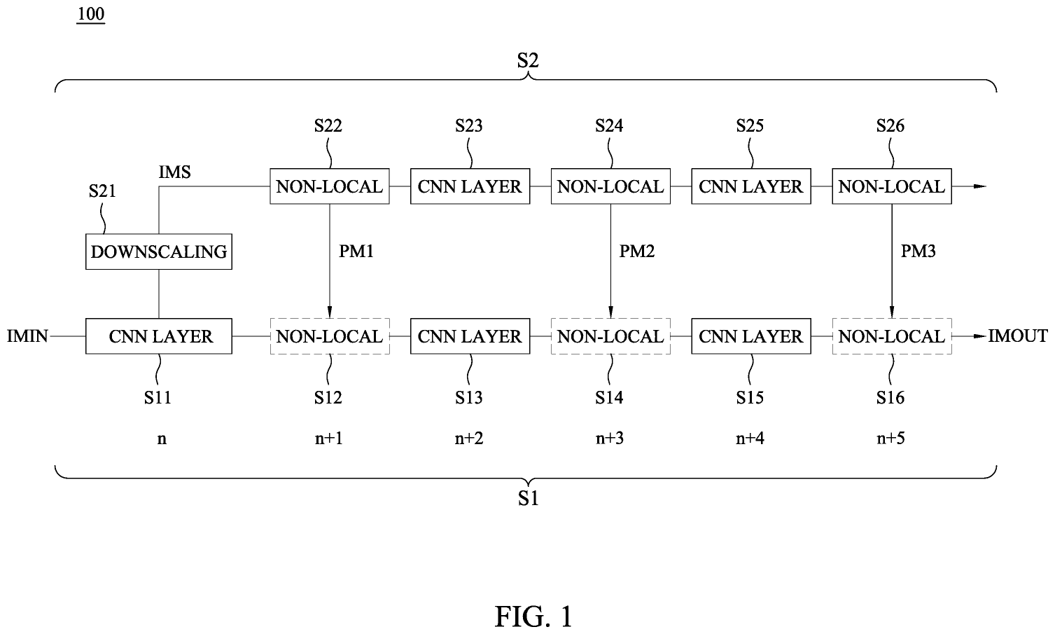

FIG. 1 is a schematic diagram of a process 100 of a convolutional neural network (CNN) system processing an input image IMIN in accordance with some embodiments of the present disclosure. As illustratively shown in FIG. 1, the process 100 includes two sub processes S1 and S2 for processing the image input image IMIN. In some embodiments, the sub process S1 is referred to as a main trunk, which is configured to perform a CNN modeling process for generating an output image IMOUT based on the input image IMIN. In some embodiments, the sub process S2 is referred to as a global branch, which is configured to perform the other CNN modeling process for providing global information of the input image IMIN to the sub process S1. In some embodiments, the global information of the input image IMIN indicates the information generated by processing the entire input image IMIN in a CNN modeling process.

In some embodiments, the sub process S1 is performed to process a portion of the input image IMIN, and the sub process S2 is performed to generate parameters PM1-PM3 which are associated with the global information of the entire input image IMIN. Accordingly, in some embodiments, the parameters PM1-PM3 are referred to as global parameters.

For illustration, the sub process S1 includes CNN operations S11, S13, S15 and non-local operations S12, S14, S16 that are performed in order as shown in FIG. 1. The sub process S2 includes an operation S21, CNN operations S23, S25 and non-local operations S22, S24, S26 that are performed in order as shown in FIG. 1.

In some embodiments, the CNN operations S11, S13, S15 correspond to an nth CNN layer, an (n+2)th CNN layer and an (n+4)th CNN layer, respectively, of a convolutional neural network, while the CNN operations S21, S23, S25 correspond to the nth CNN layer, the (n+2)th CNN layer and the (n+4)th CNN layer, respectively. It is noted that n is a positive integer. The non-local operations S12, S14, S16 correspond to an (n+1)th CNN layer, an (n+3)th CNN layer and an (n+5)th CNN layer, respectively, of the convolutional neural network, while the non-local operations S22, S24, S26 correspond to the (n+1)th CNN layer, the (n+3)th CNN layer and the (n+5)th CNN layer, respectively. The above operations are illustratively discussed below.

At the operation S21, the input image IMIN is downscaled to generate a scaled image IMS. In some embodiments, the scaled image IMS reserves global features of the input image IMIN. Alternatively stated, the global features are extracted from the input image IMIN to generate the scaled image IMS. As illustratively shown in FIG. 1, the non-local operations S22, S24, S26 and the CNN operations S23, S25 are performed to the scaled image IMS to generate parameters PM1-PM3. In other words, the parameters PM1-PM3 are extracted from the scaled image IMS.

As illustratively shown in FIG. 1, the non-local operations S12, S14, S16 and the CNN operations S13, S15 are performed for processing the input image IMIN to generate the output image IMOUT, in which the non-local operations S12, S14, S16 are performed with the parameters PM1-PM3, respectively. Because the parameters PM1-PM3 are generated by processing the scaled image IMS which reserves global features of the input image IMIN, the output image IMOUT has the global information of the input image IMIN.

In some approaches, an image is divided into independent image blocks. Each of the image blocks does not have information of other image blocks. When CNN operations are performed to one of the image blocks, global features of the image, which are associated with other image blocks, are not involved. As a result, the images blocks generated by the CNN operations are lack of the global information.

Compared to the above approaches, in some embodiments of the present disclosure, the operations S21-S26 generate the parameters PM1-PM3 associated with the global features of the input image IMIN for the operations S11-S16, such that each of the image blocks of the output image IMOUT generated by the operations S11-S16 has the global information of the input image IMIN.

In other previous approaches, CNN operations and non-local operations are performed to an entire image. In such approaches, a huge dynamic random-access memory (DRAM) bandwidth is required for transmitting information of the entire image between a chip for performing the operations and a DRAM for storing images. As a result, costs for performing the operations are huge.

Compared to the above approaches, in some embodiments of the present disclosure, the operations S12-S16 are performed, with the parameters PM1-PM3, to a portion of the input image IMIN. Data that carries the parameters PM1-PM3 and the portion of the input image IMIN have a size much smaller than a size of data that carries the entire input image IMIN, such that a requirement on the DRAM bandwidth is reduced.

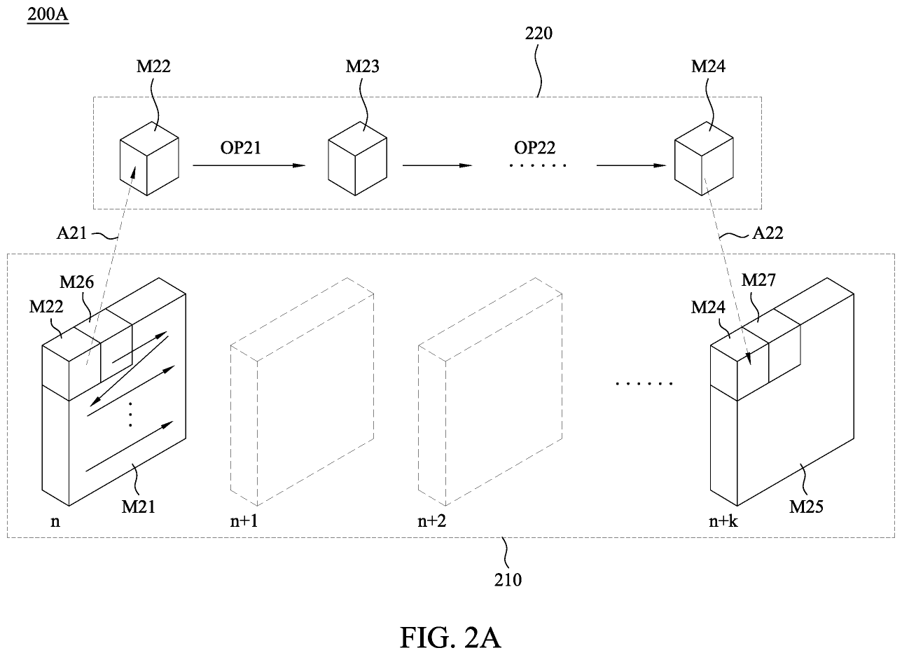

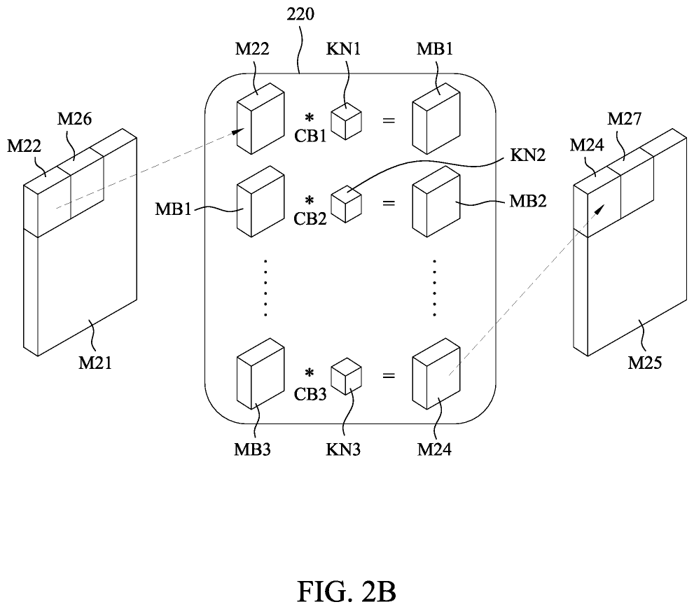

FIG. 2A is a schematic diagram of a CNN process 200A with block-based flow, corresponding to, for example, the sub process S1 as shown in FIG. 1, in accordance with some embodiments of the present disclosure. As illustratively shown in FIG. 2A, the CNN process 200A includes a memory storage operation 210 and an on-chip calculation 220. In some embodiments, the memory storage operation 210 is implemented by DRAM storage. In some embodiments, arrows A21 and A22 correspond to a DRAM bandwidth.

As illustratively shown in FIG. 2A, the memory storage operation 210 is performed to store an image M21. The image M21 is divided into image blocks including image blocks M22 and M26. The image block M22 is transmitted, along the arrow A21, to performing the on-chip calculation 220. The on-chip calculation 220 includes performing an operation OP21 to the image block M22 to generate an image block M23, and performing operations OP22 to the image block M23 to generate the image block M24. In some embodiments, the operations OP21 and OP22 include extracting global features of the image M21 for generating the image blocks M23 and M24, such that the image blocks M23 and M24 are associated with the global features of the image M21.

As illustratively shown in FIG. 2A, after the image block M24 is generated by performing the on-chip calculation 220, the image block M24 is transmitted, along the arrow A22, for performing the memory storage operation 210, and the memory storage operation 210 is performed to store the image block M24 as a portion of an image M25.

In some embodiments, after the image block M24 is stored by performing the memory storage operation 210, the on-chip calculation 220 includes transmitting another image block, such as the image block M26, for performing the on-chip calculation 220. The on-chip calculation 220 is performed to process the image block M26 to generate a corresponding image block M27 of the image M25. In some embodiments, the on-chip calculation 220 is performed to process the image blocks of the image M21 in order to generate the image M25.

In some embodiments, the image M21 and image blocks M22, M26 correspond to the nth CNN layer, the image block M23 corresponds to the (n+1)th CNN layer, and the image M25 and image blocks M22, M27 correspond to the (n+k)th CNN layer. As illustratively shown in FIG. 2A, entire images of intermediate layers (for example, (n+1)th CNN layer and (n+2)th CNN layer) are not transmitted to perform the on-chip calculation 220.

Referring to FIG. 1 and FIG. 2A, the image M21 corresponds to the input image IMIN, the image block M24 correspond to the output image IMOUT, and the operations OP21 and OP22 correspond to the operations S12-S16. In some embodiments, the operations S11-S16 and S21-S26 correspond to the on-chip calculation 220.

FIG. 2B is a schematic diagram of further details of performing the on-chip calculation 220 for CNN operations with block-based flow, in accordance with some embodiments of the present disclosure.

As illustratively shown in FIG. 2B, the on-chip calculation 220 includes receiving the image block M22, and includes a convolution operation CB1 with a kernel KN1 to the image block M22 to generate an image block MB1. In some embodiments, the on-chip calculation 220 further includes performing multiple convolution operations with corresponding kernels to generate the image block M24. For example, the on-chip calculation 220 includes a convolution operation CB2 with a kernel KN2 to the image block MB1 to generate an image block MB2, performs multiple convolution operations to the image block MB2 to generate an image block MB3, and performs a convolution operation CB3 with a kernel KN3 to the image block MB3 to generate the image block M24.

In some embodiments, non-local operations, such as the operations S12, S14 and S16 shown in FIG. 1, are performed among the convolution operations. For example, the non-local operation S12 is performed to the image block M22 before the convolution operation CB1, and the non-local operation S14 is performed to the image block MB1 before the convolution operation CB2. Accordingly, the intermediate image blocks MB1-MB3 have non-local information of the entire image M21. As a result, the image block M24 generated by performing the on-chip calculation 220 also has the non-local information.

Referring to FIG. 1 and FIG. 2B, the convolution operations CB1 and CB2 correspond to the operations S13 and S15, respectively. In some embodiments, the operations S13 and S23 are on a same CNN layer, and both are performed with the kernel KN1. Similarly, the operations S15 and S25 are on a same CNN layer, and both are performed with the kernel KN2.

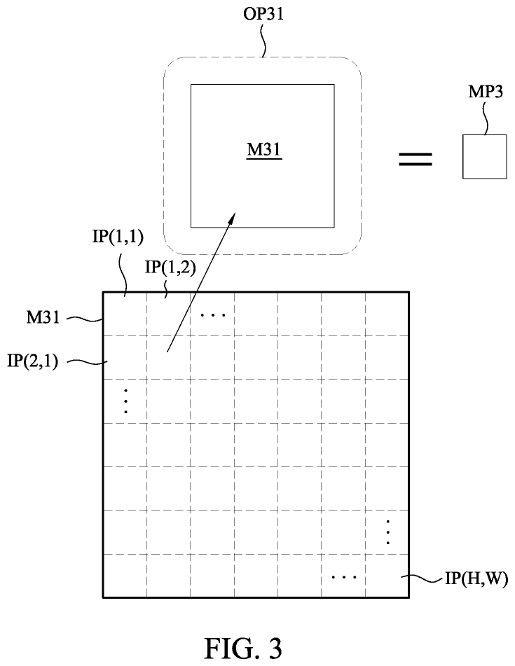

FIG. 3 is a schematic diagram of processing a non-local operation OP31 to a feature map M31, corresponding to, for example, the operation S22 as shown in FIG. 1, in accordance with some embodiments of the present disclosure. As illustratively shown in FIG. 3, the feature map M31 includes H×W pixels IP(1,1)-IP(H,W), in which the positive integers H and W are height and width of the feature map M31, respectively. The non-local operation OP31 is performed to the entire feature map M31 to generate a pixel MP3 of an output image. The output image includes H×W pixels corresponding to the pixels IP(1,1)-IP(H,W), respectively. In other embodiments, the pixel MP3 is a pixel of an intermediate image generated during the entire CNN modeling process for generating the output image.

In some embodiments, the feature map M31 is transformed into the output image. In some embodiments, the operation OP31 is performed on an instance normalization (IN) layer, and the pixels IP(1,1)-IP(H,W) of the feature map M31 are transformed to the pixel MP3. In some embodiments, to transform the pixels IP(1,1)-IP(H,W), values of the pixels IP(1,1)-IP(H,W) are calculated or normalized based on some parameters associated with the feature map M31. For example, when the pixel MP3 corresponds to the pixel IP(i, j), a value VMP3(i, j) of the pixel MP3 is calculated by following equation (1):

$$VMP 3 ( i , j ) = A ( \frac{X ( i , j ) - U}{\sqrt{{Q}^{2} + E}} ) + B . \qquad ( 1 )$$

The width index i is a positive integer smaller than W, the height index j is a positive integer smaller than H, the value X(i, j) is the value of the pixel IP(i, j), the parameter U is a mean value of the feature map M31, the parameter Q is a standard deviation of the image M31, the parameter E is a positive real number for preventing the denominator being zero, and the parameters A and B are affine parameters determined before the non-local operation OP31.

In some embodiments, the parameter E is equal to 10⁻⁵, and the parameters U and Q are a mean value and a standard derivative of the feature map M31, respectively. In some embodiments, the parameters Q and U are calculated by following equations (2) and (3):

$$U = \frac{1}{H \times W} {\sum }_{i = 1}^{W} {\sum }_{j = 1}^{H} X ( i , j ) ; \qquad ( 2 )$$

$$Q = \frac{1}{H \times W} {\sum }_{i = 1}^{W} {\sum }_{j = 1}^{H} {( X ( i , j ) - U )}^{2} . \qquad ( 3 )$$

As described above, the pixel MP3 is obtained based on the entire feature map M31. Accordingly, the pixel MP3 has information of global features of the feature map M31.

In some embodiments, the pixels IP(1,1)-IP(H,W) are specified to a certain channel and a certain batch. Accordingly, the equations depend on a channel index c and batch index b in some embodiments. For example, the parameters Q, U and the value VMP3(i, j) are calculated by following equations:

$$U ( b , c ) = \frac{1}{H \times W} {\sum }_{i = 1}^{W} {\sum }_{j = 1}^{H} X ( i , j , b , c ) ;$$

$$Q ( b , c ) = \frac{1}{H \times W} {\sum }_{i = 1}^{W} {\sum }_{j = 1}^{H} {( X ( i , j , b , c ) - U ( b , c ) )}^{2} ;$$

$$VMP 3 ( i , j , b , c ) = A ( \frac{X ( i , j , b , c ) - U ( b , c )}{\sqrt{{Q}^{2} ( b , c ) + E}} ) + B .$$

Referring to FIG. 1 and FIG. 3, the feature map M31 corresponds to the scaled image IMS, and the operation OP31 corresponds to the operation S22. In some embodiments, the operation S22 is performed to generate an image having pixels each associated with the entire scaled image IMS. In some embodiments, the operation S22 is performed to transform the scaled image IMS into an intermediate image based on the parameters PM1.

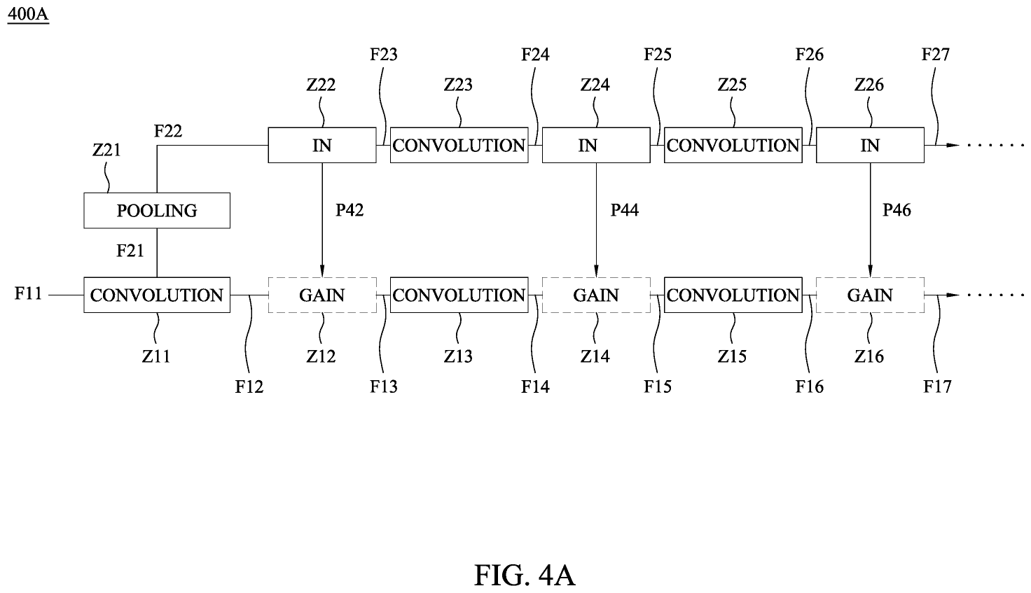

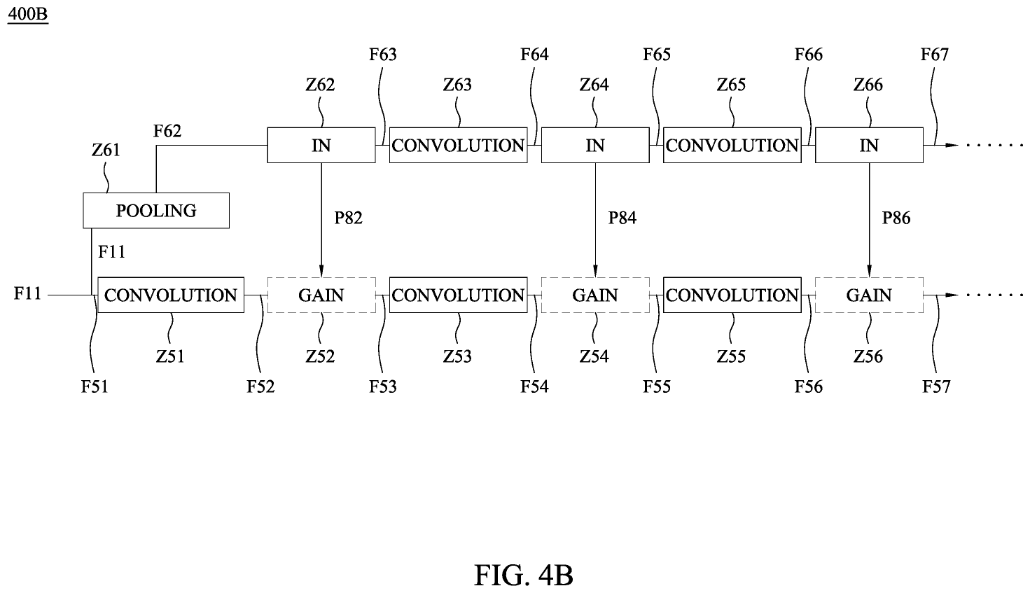

FIG. 4A is a flowchart of a method 400A, corresponding to the process 100 as shown in FIG. 1, of a CNN system processing an image F11 in accordance with some embodiments of the present disclosure. As illustratively shown in FIG. 4A, the method 400A includes operations Z11-Z16 and Z21-Z26 for processing the image F11 to generate images F21-F27 and F12-F17. In some embodiments, the operations Z11-Z16 are performed in order, and the operations Z21-Z26 are performed in order. In some embodiments, the operations Z21-Z26 are performed before the operations Z11-Z16 are performed. In some embodiments, the operations Z11-Z16 and Z21-Z26 correspond to two convolutional neural networks (CNN) modeling process, respectively.

Referring to FIG. 1 and FIG. 4A, the method 400A is an embodiment of the method 100. The operations Z11-Z16 and Z21-Z26 correspond to the operations S11-S16 and S21-S26, respectively. The input image IMIN, the output image IMOUT and the scaled image IMS correspond to the images F11, F17 and F22, respectively. The operations Z11-Z16 correspond to a main trunk, and the operations Z21-Z26 correspond to a global branch. Therefore, some descriptions are not repeated for brevity.

As illustratively shown in FIG. 4A, at the operation Z11, a convolution operation is performed with a kernel to the image F11 to generate the images F21 and F12. The image F21 corresponds to the entire image F11 and has a size same as a size of the image F11. In some embodiments, a number of pixels of the image F21 is same as a number of pixels of the image F11. The image F12 is a portion of the image F21. In some embodiments, at the operation Z11, the image F21 is divided into image blocks, in which the image F12 is one of the image blocks.

Referring to FIG. 4A and FIG. 2A, the images F21 and F12 correspond to the image M21 and the image block M22, respectively. In some embodiments, the memory storage operation 210 is performed to store the image F21, and configured to transmit the image F12 for performing the on-chip calculation 220. In some embodiments, the on-chip calculation 220 includes processing the image F12 to generate the image F17, and transmitting the image F17 for the memory storage operation 210.

As illustratively shown in FIG. 4A, at the operation Z21, the image F22 is generated based on the image F21. In some embodiments, the image F21 is downscaled to generate the image F22. For example, a pooling operation is performed to select a number, such as 64×64, of pixels from pixels of the image F21 to generate the image F22. In some embodiments, the selected pixels present global features of the image F21, and the image F22 has the global features of the image F21.

At the operation Z22, a non-local operation is performed to the image F22 to generate the image F23. In some embodiments, parameters P42 are generated for generating the image F23. In other words, the parameters P42 are extracted from the image F22. Referring to FIG. 3 and FIG. 4A, in some embodiments, the equations (1)-(3) of instance normalization (IN) are applied to image F22 in the same manner as being applied to the feature map M31 to generate the parameters P42. In other words, the parameters P42 include a mean value U2 and a standard derivative Q2 which are calculated by following equations:

$$U 2 = \frac{1}{H 1 \times W 1} {\sum }_{i = 1}^{W 1} {\sum }_{j = 1}^{H 1} X 2 ( i , j ) ;$$

$$Q 2 = \frac{1}{H 1 \times W 1} {\sum }_{i = 1}^{W 1} {\sum }_{j = 1}^{H 1} {( X 2 ( i , j ) - U 2 )}^{2} .$$

Accordingly, a value V3(i, j) of a pixel, having a width index i and a height index j, of the image F23 is calculated by following equation:

$$V 3 ( i , j ) = A 2 ( \frac{X 2 ( i , j ) - U 2}{\sqrt{Q {2}^{2} + E}} ) + B 2. \qquad ( 1 )$$

The positive integers H1 and W1 are height and width of the feature map M31, respectively. In some embodiments, H1×W1 pixels are chosen from the image F21 to generate the image F22. The value X2(i, j) is the value of a pixel, having a width index i and a height index j, of the image F22. The parameters A2 and B2 are affine parameters pre-determined corresponding to the non-local operation Z22.

As described above, the image F23 is generated based on the image F22 and the parameters P42. In some embodiments, the image F22 is transformed into the image F23 based on the parameters P42.

As illustratively shown in FIG. 4A, at the operation Z23, a convolution operation is performed with a kernel to the image F23 to generate the images F24.

At the operation Z24, a non-local operation is performed to the image F24 to generate the image F25. Calculations for generating the parameters P44 and the image F25 based on the image F24 are similar with the calculation for generating the parameters P42 and the image F23 based on the image F22 as described above. Therefore, some descriptions are not repeated for brevity.

In some embodiments, the image F25 is generated based on the image F24 and the parameters P44. In some embodiments, the image F24 is transformed into the image F25 based on the parameters P44.

At the operation Z25, a convolution operation is performed with a kernel to the image F25 to generate the images F26.

At the operation Z26, a non-local operation is performed to the image F26 to generate the image F27. Calculations for generating the parameters P46 and the image F27 based on the image F26 are similar with the calculation for generating the parameters P42 and the image F23 based on the image F22 as described above. Therefore, some descriptions are not repeated for brevity.

In some embodiments, after the operation Z26, convolution operations similar with the operation Z23 and non-local operations similar with the operation Z24 are performed alternately in the global branch to generate more intermediate images and corresponding global parameters.

In some embodiments, each of the images F22-F27 has a same size and a same number of pixels. In some embodiments, the images F22-F27 correspond to a scaled version of the image F21, and thus the images F22-F27 are referred to as scaled images.

In some embodiments, the images F23-F26 are generated during the entire CNN modeling process for generating the output image, and thus the images F23-F26 are referred to as intermediate images.

In some embodiments, the image F12 is transformed into the image F13 based on the parameters P42. At the operation Z12, a non-local operation is performed, with the parameters P42, to the image F12 to generate the image F13. In some embodiments, to transform the pixels of the image F12 into the pixels of the image F13, the pixels of the image F12 are calculated or normalized based on the parameters P42. In other word, the pixels of the image F13 are evaluated based on the parameters P42 and pixels of the image F12. For example, a value Y3(i, j) of a pixel, having a width index i and a height index j, of the image F13 is calculated by following equations:

$$Y 3 ( i , j ) = A 2 ( \frac{Y 2 ( i , j ) - U 2}{\sqrt{Q {2}^{2} + E}} ) + B 2. \qquad ( 1 )$$

The value Y2(i,j) is the value of one of the pixels, having a width index i and a height index j, of the image F12. In some embodiments, at the operation Z12, the image F13 is generated based on the global parameters U2 and Q2 from the global branch, and the operation Z12 is referred to as global assisted instance normalization (GAIN).

At the operation Z13, a convolution operation is performed with a kernel to the image F13 to generate the images F14. In some embodiments, the operations Z13 and Z23 are on a same CNN layer, and both are performed with a same kernel.

At the operation Z14, a non-local operation is performed, with the parameters P44, to the image F14 to generate the image F15. In some embodiments, pixels of the image F15 are evaluated based on the parameters P44 and pixels of the image F14. Calculations for generating the image F15 based on the image F14 and the parameters P44 are similar with the calculation for generating the image F13 based on the image F12 and the parameters P42 as described above. Therefore, some descriptions are not repeated for brevity.

At the operation Z15, a convolution operation is performed with a kernel to the image F15 to generate the images F16. In some embodiments, the operations Z15 and Z25 are on a same CNN layer, and both are performed with a same kernel.

At the operation Z16, a non-local operation is performed, with the parameters P46, to the image F16 to generate the image F17. In some embodiments, pixels of the image F17 are evaluated based on the parameters P46 and pixels of the image F16. Calculations for generating the image F17 based on the image F16 and the parameters P46 are similar with the calculation for generating the image F13 based on the image F12 and the parameters P42 as described above. Therefore, some descriptions are not repeated for brevity.

In some embodiments, the image F17 is an image block of the output image. In other embodiments, after the operation Z16, convolution operations similar with the operation Z13 and non-local operations similar with the operation Z14 are performed alternately in the main trunk to generate more intermediate image blocks for the output image.

In some embodiments, each of the images F12-F17 has a same size and a same number of pixels. In some embodiments, the images F12-F17 correspond to an image block of the image F21, and thus the images F12-F17 are referred to as image blocks. In some embodiments, the images F13-F16 are generated during the entire CNN modeling process for generating the output image, and thus the images F13-F16 are referred to as intermediate images.

In summary, the images F13-F17 in the main trunk are generated based on the global parameters P42, P44 and P46 generated by the global branch, and thus the images F13-F17 corresponding to an image block of the image F21 have the global information of the entire image F21.

FIG. 4B is a flowchart of a method 400B, corresponding to the process 100 as shown in FIG. 1, of a CNN system processing the image F11 in accordance with some embodiments of the present disclosure. As illustratively shown in FIG. 4B, the method 400B includes operations Z51-Z56 and Z61-Z66 for processing the image F11 to generate images F62-F67, F52-F57 and global parameters P82, P84, P86.

Referring to FIG. 4B and FIG. 4A, the method 400B is an alternative embodiment of the method 400A. The operations Z51-Z56 and Z61-Z66 correspond to the operations Z11-Z16 and Z21-Z26, respectively. The images F62-F67 and F52-F57 correspond to the images F22-F27 and F12-F17, respectively. The global parameters P82, P84, P86 correspond to the global parameters P42, P44, P46, respectively. Therefore, some descriptions are not repeated for brevity.

As illustratively shown in FIG. 4B, before the operation Z51, an image F51 is generated based on the image F11. In some embodiments, the image F11 is divided into image blocks, and the image F51 is one of the image blocks.

As illustratively shown in FIG. 4B, at the operation Z61, an image F62 is generated based on the image F11. In some embodiments, the image F11 is downscaled to generate the image F62.

Referring to FIG. 4B and FIG. 4A, in some embodiments, the relationship between the images F11, F51 and F62 shown in FIG. 4B is similar to the relationship between the images F21, F12 and F22. The calculations associated with the global parameters P82, P84, P86 are similar with calculations associated with the global parameters P42, P44, P46. Therefore, some descriptions are not repeated for brevity.

As illustratively shown in FIG. 4B, at the operation Z51, a convolution operation is performed with a kernel to the image F51 to generate the image F52. The operations Z52-Z56 are performed to the image F52 to generate the images F53-F57.

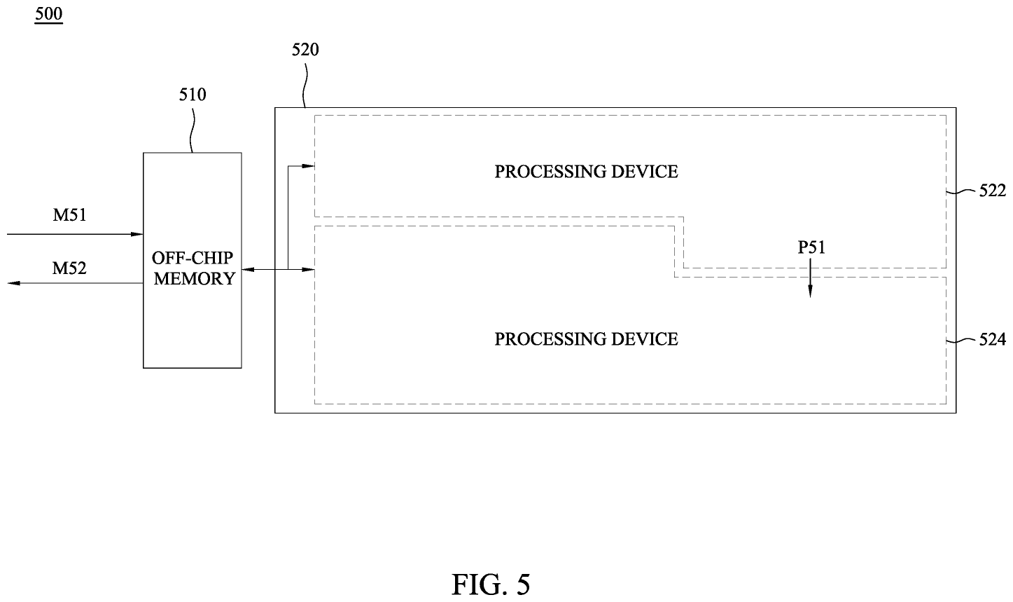

FIG. 5 is a schematic diagram of a system 500 performing a CNN modeling process, for example, corresponding to the process 100 as shown in FIG. 1, in accordance with some embodiments of the present disclosure. As illustratively shown in FIG. 5, the system 500 includes a memory 510 and a chip 520. In some embodiments, the memory 510 is implemented as DRAM storage and/or the chip 520 is implemented as a central processing unit (CPU). In some embodiments, the chip 520 is separated from the memory 510. In other words, the memory 510 is an off-chip memory.

As illustratively shown in FIG. 5, the memory 510 is configured to receive and store an input image M51, and configured to store and output an output image M52. The chip 520 is configured to process the input image M51 and generate the output image M52 based on the image M51. In some embodiments, data associated with the input image M51 and the output image M52 are transmitted between the memory 510 and the chip 520. In some embodiments, the transmission between the memory 510 and the chip 520 corresponds to DRAM bandwidth.

Referring to FIG. 5 and FIG. 2A, the system 500A is an embodiment of the system 200A. The memory 510 and the chip 520 correspond to the memory storage operation 210 and the on-chip calculation 220, respectively. In some embodiments, the memory 510 is configured to store the image M21, and the chip 520 is configured to process the image block M22 to generate the image block M24.

In some embodiments, the chip 520 is configured to generate parameters that associated with scaled images associated with non-local information of the image M51, in which each of the scaled images has a size smaller than a size of the image M51.

Referring to FIGS. 1-5, in some embodiments, the chip 520 is configured to perform the operations shown in FIGS. 1-4B, such as the operations S11-S16, S21-S26, OP21, OP22, CB1-CB3, OP31, Z11-Z16, Z21-Z26, Z51-Z56 and Z61-Z66.

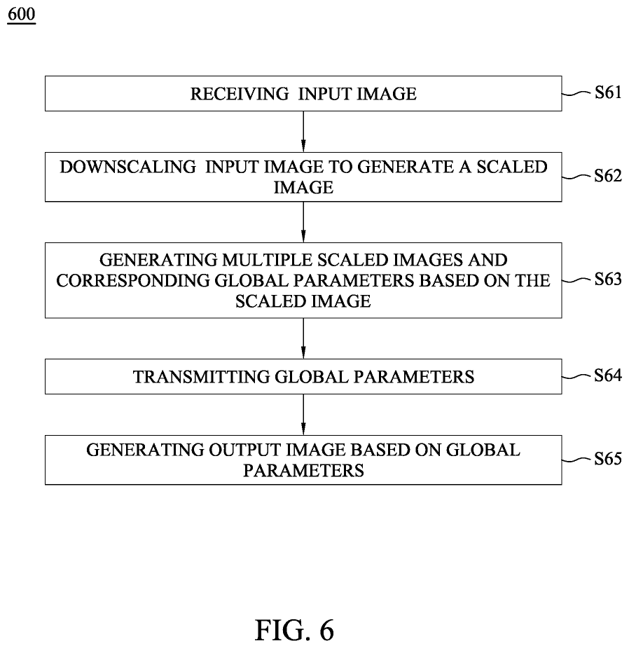

As illustratively shown in FIG. 5, the chip 520 includes processing devices 522 and 524. The processing devices 522 and 524 correspond to the global branch and the main trunk, respectively. In some embodiments, the processing device 522 is configured to downscale the image M51, and configured to store global parameters associated with the image M51. The processing device 524 is configured to receive the global parameters from the processing device 522 and receive the image M51, and configured to generate a portion of the image M52 based on a portion of the image M51 and the global parameters. In some embodiments, the chip is further configured to process, by performing convolutional neural networks (CNN) operations (for example, the operations Z23 and Z25 shown in FIG. 4A) with non-local operations (for example, the operations Z22, Z24 and Z26 shown in FIG. 4A), the image M21 being downscaled, to generate multiple scaled images. Further details of operations of the processing devices 522 and 524 are described below with reference to embodiments shown in FIG. 6.

FIG. 6 is a flowchart of a method 600 of a CNN system, for example, the system 500 as shown in FIG. 5, processing an input image to generate an output image in accordance with some embodiments of the present disclosure. As illustratively shown in FIG. 6, the method 600 includes operations S61-S65. In following description, the operations S61-S65 are performed by the system 500 shown in FIG. 5, but not limited to this. In various embodiments, the operations S61-S65 are performed by various systems having various configurations different from the system 500.

At the operation S61, the chip 520 receives the input image M51. In some embodiments, the processing device 524 is configured to process an image block of the input image M51.

At the operation S62, the processing device 522 downscales the input image M51 to generate a first scaled image having global features of the input image M51. In some embodiments, the operation S62 includes sampling and/or pooling the image M51.

At the operation S63, the chip 520 generates multiple scaled images and corresponding global parameters P51 based on the first scaled image. In various embodiments, the operation S63 is performed by either one of the processing devices 522 and 524. In some embodiments, the processing device 522 is configured to store the global parameters P51.

At the operation S64, the processing device 522 transmits the global parameters P51 from the processing device 522 to the processing device 524.

At the operation S65, the processing device 524 generates an image block of the output image M52 based on the global parameters P51. In some embodiments, the processing device 524 further generates intermediate image blocks for generating the output image M52.

Referring to FIG. 6 and FIG. 4A, the operation S62 corresponds to the operation Z21, the operation S63 corresponds to the operations Z22-Z26, and the operation S65 corresponds to the operations Z12-Z16. For example, the operation S63 includes at least one of the operations Z22-Z26, and the operation S65 includes at least one of the operations Z12-Z16.

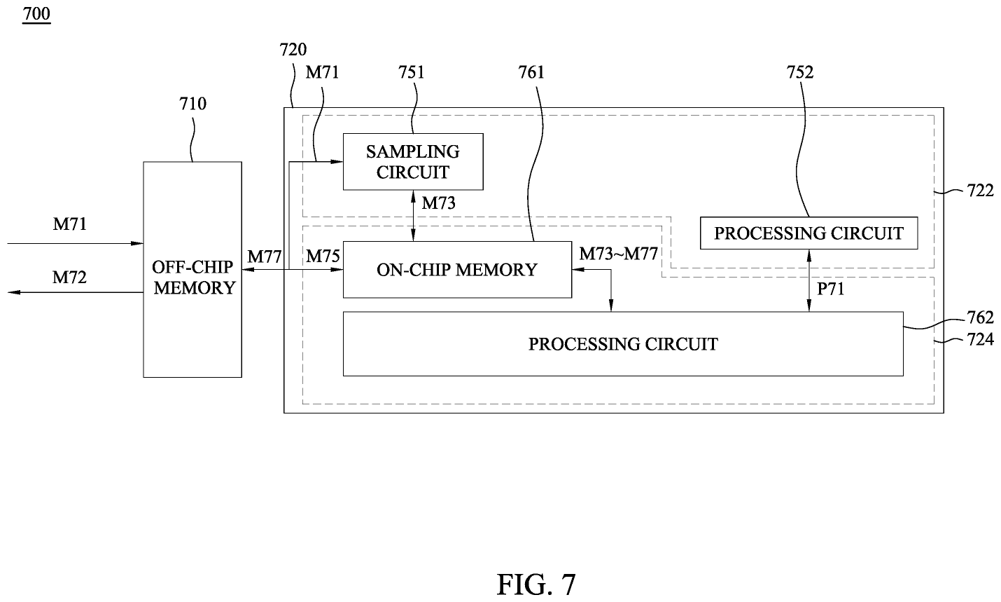

FIG. 7 is a schematic diagram of a system 700, corresponding to the system 500 as shown in FIG. 5, performing a CNN modeling process, in accordance with some embodiments of the present disclosure. As illustratively shown in FIG. 7, the system 700 includes a memory 710 and a chip 720. The memory 710 is configured to receive and store an input image M71, and configured to store and output an output image M72. The chip 720 includes processing devices 722 and 724 for generating the output image M72 based on the input image M71.

Referring to FIG. 5 and FIG. 7, the system 700 is an embodiment of the system 500. The memory 710, the chip 720, the input image M71, the output image M72 and the processing devices 722 and 724 correspond to the memory 510, the chip 520, the input image M51, the output image M52 and the processing devices 522 and 524, respectively. Therefore, some descriptions are not repeated for brevity.

As illustratively shown in FIG. 7, the processing device 722 includes a sampling circuit 751 and a memory circuit 752. The sampling circuit 751 is configured to downscale the input image M71 to generate a scaled image M73. The memory circuit 752 is configured to store global parameters P71 and configured to transmit the global parameters P71 to the processing device 724.

As illustratively shown in FIG. 7, the processing device 724 includes a memory circuit 761 and a processing circuit 762. The memory circuit 761 is configured to receive and store the scaled image M73 from the sampling circuit 751, and configured to provide the scaled image M73 to the processing circuit 762. The processing circuit 762 is configured to generate multiple scaled images M74 and the corresponding global parameters P71 based on the scaled image M73.

In some embodiments, after the global parameters P71 are generated and stored in the memory circuit 752, the memory circuit 761 is further configured to receive an image block M75 of the input image M71. The processing circuit 762 is further configured to generate multiple image blocks M76 based on the image block M75 and the global parameters P71, to generate an image block M77 of the output image M72. In some embodiments, the memory circuit 761 is further configured to receive and store the image blocks M75-M77 from the processing circuit 762, and configured to transmit the image block M77 to the memory 710.

Referring to FIG. 4A and FIG. 7, the image M71 corresponds to the image F21, the scaled image M73 corresponds to the image F22, the scaled images M74 correspond to the images F23-F26, the image block M75 corresponds to the image F12, the image blocks M76 correspond to the images F13-F16, and the global parameters P71 correspond to the parameters P42, P44 and P46.

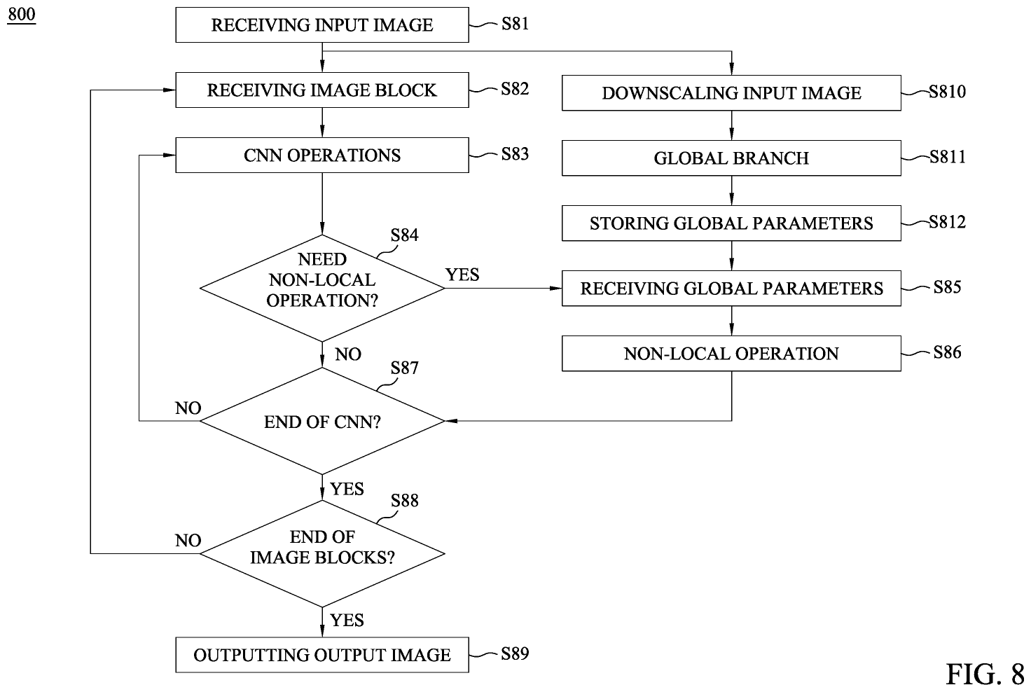

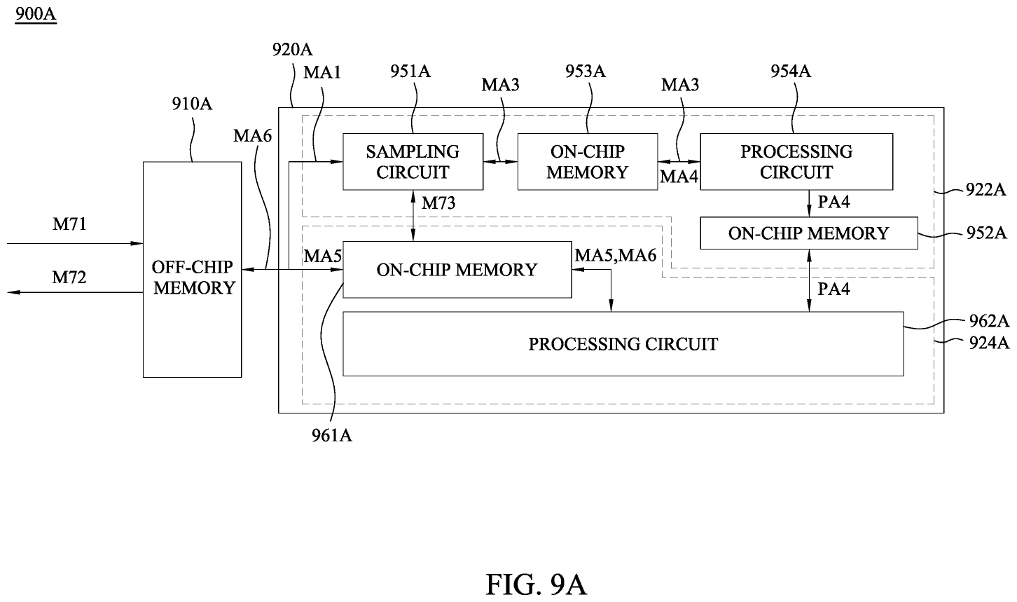

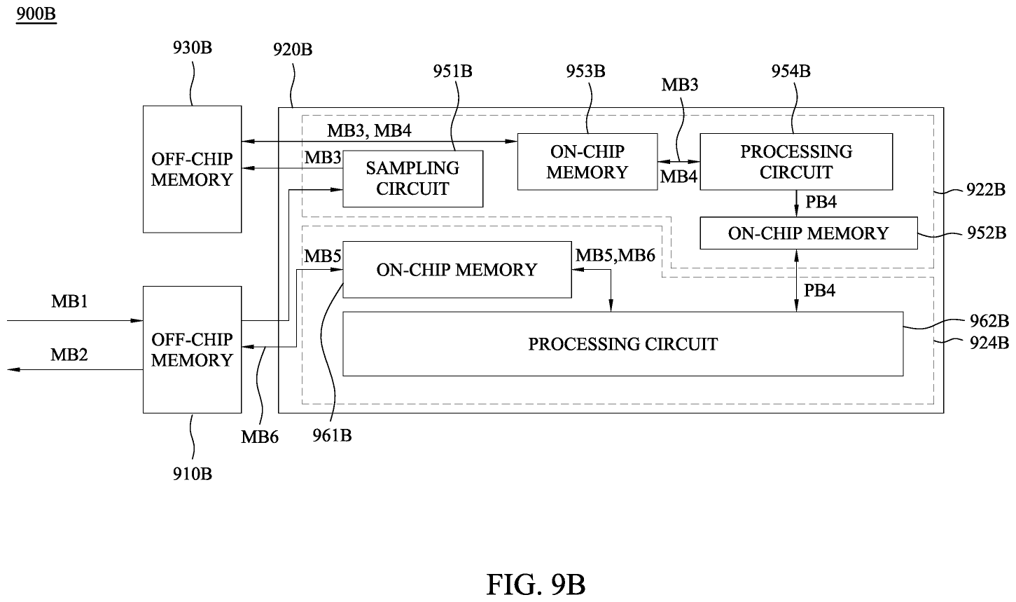

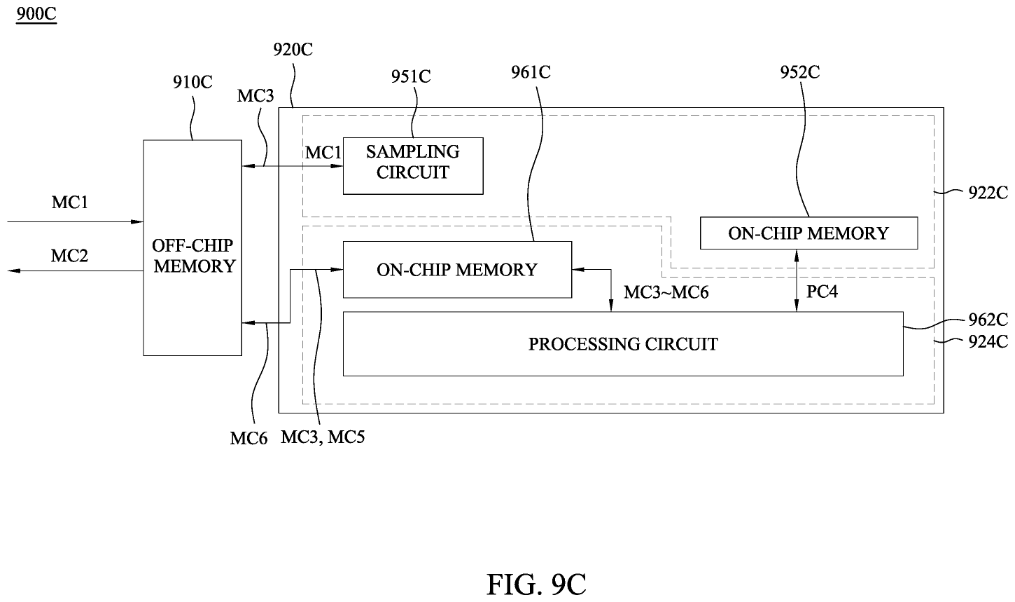

FIG. 8 is a flowchart of a method 800 of a CNN system, such as the system 700 as shown in FIG. 7, for processing an input image to generate an output image in accordance with some embodiments of the present disclosure. As illustratively shown in FIG. 8, the method 800 includes operations S81-S812. In following description, the operations S81-S812 are performed by the system 700 shown in FIG. 7, but not limited to this. In various embodiments, the operations S81-S812 are performed by various systems having various configurations different from the system 700, such as the systems 900A-900C shown in FIGS. 9A-9C described below.

At the operation S81, the memory 710 receives the input image M71.

At the operation S810, the sampling circuit 751 downscales the input image M71 to generate the scaled image M73 having global features of the input image M71.

At the operation S811, the processing circuit 762 performs CNN operations and non-local operations in the global branch, such as the operations Z22-Z26 and Z62-Z66 shown in FIGS. 4A-4B, to the image M73 to generate the scaled images M74 and the global parameters P71.

At the operation S812, the memory circuit 752 receives the global parameters P71 from the processing circuit 762 and stores the global parameters P71.

At the operation S82, the processing circuit 762 receives the image block M75 of the input image M71 from the memory 710.

At the operation S83, the processing circuit 762 performs CNN operations, such as the operations Z13, Z15, Z51, Z53 and Z55 shown in FIGS. 4A-4B, to the image block M75 to generate one of the image blocks M76.

At the operation S84, the processing circuit 762 is configured to determine whether the one of the image blocks M76 needs to be processed by a non-local operation. If the one of the image blocks M76 needs to be processed by a non-local operation, the operation S85 is performed after the operation S84. If the one of the image blocks M76 does not need to be processed by a non-local operation, the operation S87 is performed after the operation S84.

At the operation S85, the processing circuit 762 receives the global parameters P71 from the memory circuit 752.

At the operation S86, the processing circuit 762 applies global features to the one of the image blocks M76 by performing a non-local operation, such as the operations Z12, Z14, Z16, Z52, Z54 and Z56 shown in FIGS. 4A-4B, with the global parameters P71.

At the operation S87, the processing circuit 762 determines whether the CNN modeling process is end. If the CNN modeling process is end, the operation S88 is performed after the operation S87, and the image block M77 is transmitted to the memory 710. If the CNN modeling process is not end, the operation S83 is performed after the operation S87, to proceed to a next CNN layer.

At the operation S88, the processing circuit 762 determines whether the image blocks of the entire image M71 are processed. In other word, the processing circuit 762 determines whether the image blocks of the entire output image M72 are generated. If the image blocks of the entire output image M72 are generated, the operation S89 is performed after the operation S88. If some of the image blocks of the output image M72 are not generated yet, the operation S82 is performed after the operation S88, to process another image block of the input image M71.

At the operation S89, the memory 710 outputs the output image M72.

FIG. 9A is schematic diagrams of a system 900A, corresponding to the system 500 as shown in FIG. 5, performing a CNN modeling process, in accordance with some embodiments of the present disclosure. As illustratively shown in FIG. 9A, the system 900A includes a memory 910A and a chip 920A. The memory 910A is configured to receive and store an input image MA1, and configured to store and output an output image MA2. The chip 920A includes processing devices 922A and 924B.

Referring to FIG. 5 and FIG. 9A, the system 900A is an embodiment of the system 500. The memory 910A, the chip 920A, the input image MA1, the output image MA2 and the processing devices 922A and 924A correspond to the memory 510, the chip 520, the input image M51, the output image M52 and the processing devices 522 and 524, respectively. Therefore, some descriptions are not repeated for brevity.

As illustratively shown in FIG. 9A, the processing device 922A includes a sampling circuit 951A, memory circuits 952A, 953A and a processing circuit 954A. In some embodiments, the sampling circuit 951A is configured to downscale the input image MA1 to generate a scaled image MA3. The memory circuit 953A is configured to receive and store the scaled image MA3. The processing circuit 954A is configured to perform operations in a global branch, such as the operations Z22-Z26 shown in FIG. 4A, to the scaled image MA3 to generate multiple scaled images MA4 and corresponding global parameters PA4. The memory circuit 953A is further configured to receive and store the scaled images MA4. The memory circuit 952A is configured to receive and store the global parameters PA4.

As illustratively shown in FIG. 9A, the processing device 924A includes a memory circuit 961A and a processing circuit 962A. In some embodiments, the memory circuit 961A is configured to receive an image block MA5 of the input image MA1. The processing circuit 962A is configured to receive the image block MA5 and the global parameters PA4 from the memory circuit 961A and the memory circuit 952A, respectively, and configured to perform operations of a global branch, such as the operations Z12-Z16 shown in FIG. 4A, based on the image block MA5 and the global parameters PA4, to generate an image block MA6 of the output image MA2.

FIG. 9B is schematic diagrams of a system 900B, corresponding to the system 500 as shown in FIG. 5, performing a CNN modeling process, in accordance with some embodiments of the present disclosure. As illustratively shown in FIG. 9B, the system 900B includes memories 910B, 930B and a chip 920B. The memory 910B is configured to receive and store an input image MB1, and configured to store and output an output image MB2. The chip 920B includes processing devices 922B and 924B. The memory 930B is configured to receive and store data associated with the global branch. In some embodiments, the memory 930B is an off-chip memory separated from the memory 910B and the chip 920B.

Referring to FIG. 5 and FIG. 9B, the system 900B is an embodiment of the system 500. The memory 910B, the chip 920B, the input image MB1, the output image MB2 and the processing devices 922B and 924B correspond to the memory 510, the chip 520, the input image M51, the output image M52 and the processing devices 522 and 524, respectively. Therefore, some descriptions are not repeated for brevity.

As illustratively shown in FIG. 9B, the processing device 922B includes a sampling circuit 951B, memory circuits 952B, 953B and a processing circuit 954B. In some embodiments, the sampling circuit 951B is configured to downscale the input image MB1 to generate a scaled image MB3. The memory circuit 953B is configured to receive and store the scaled image MB3. The processing circuit 954B is configured to perform operations in a global branch, such as the operations Z22-Z26 shown in FIG. 4A, to the scaled image MB3 to generate multiple scaled images MB4 and corresponding global parameters PB4. The memory circuit 953B is further configured to receive and store the scaled images MB4. The memory circuit 952B is configured to receive and store the global parameters PB4.

In some embodiments, the memory 930B is configured to receive the scaled image MB3 from the sampling circuit 951B, and transmit the scaled image MB3 to the memory circuit 953B. In some embodiments, the memory 930B is configured to receive and store the scaled images MB4. In some embodiments, the memory circuit 953B is configured store a part of the scaled images MB4, and the processing circuit 954B is configured to calculate the global parameters PB4 based on the part of the scaled images MB4.

As illustratively shown in FIG. 9B, the processing device 924B includes a memory circuit 961B and a processing circuit 962B. In some embodiments, the memory circuit 961B is configured to receive an image block MB5 of the input image MB1. The processing circuit 962B is configured to receive the image block MB5 and the global parameters PB4 from the memory circuit 961B and the memory circuit 952B, respectively, and configured to perform operations of a global branch, such as the operations Z12-Z16 shown in FIG. 4A, based on the block MB5 and the global parameters PB4, to generate an image block MB6 of the output image MB2.

FIG. 9C is schematic diagrams of a system 900C, corresponding to the system 500 as shown in FIG. 5, performing a CNN modeling process, in accordance with some embodiments of the present disclosure. As illustratively shown in FIG. 9C, the system 900C includes memories 910C, 930C and a chip 920C. The memory 910C is configured to receive and store an input image MC1, and configured to store and output an output image MC2. The chip 920C includes processing devices 922C and 924C.

Referring to FIG. 5 and FIG. 9C, the system 900C is an embodiment of the system 500. The memory 910C, the chip 920C, the input image MC1, the output image MC2 and the processing devices 922C and 924C correspond to the memory 510, the chip 520, the input image M51, the output image M52 and the processing devices 522 and 524, respectively. Therefore, some descriptions are not repeated for brevity.

As illustratively shown in FIG. 9C, the processing device 922C includes a sampling circuit 951C and a memory circuit 952C. In some embodiments, the sampling circuit 951C is configured to downscale the input image MC1 to generate a scaled image MC3, and configured to transmit the scaled image MC3 to the memory 910C. The memory circuit 952C is configured to receive the global parameters PC4 from the processing device 924C and store the global parameters PC4.

As illustratively shown in FIG. 9C, the processing device 924C includes a memory circuit 961C and a processing circuit 962C. The memory circuit 961C is configured to receive and store the scaled image MC3 from the memory 910C, and configured to provide the scaled image MC3 to the processing circuit 962C. The processing circuit 962C is configured to generate multiple scaled images MC4 and the corresponding global parameters PC4. In some embodiments, the memory circuit 961C is further configured to store the scaled images MC4.

In some embodiments, after the global parameters PC4 are generated and stored in the memory circuit 952C, the memory circuit 961C is configured to receive an image block MC5 of the input image MC1. The processing circuit 962C is configured to receive the image block MC5 and the global parameters PC4 from the memory circuit 961C and the memory circuit 952C, respectively, and configured to perform operations of a main trunk, such as the operations Z12-Z16 shown in FIG. 4A, based on the block MC5 and the global parameters PC4, to generate an image block MC6 of the output image MC2.

With respect to the methods 100 and 400A in FIG. 1 and FIG. 4A, an image block of the input image IMIN is generated with global information which occupies small DRAM bandwidth.

Also disclosed is a method including: downscaling an input image to generate a scaled image; performing, to the scaled image, a first convolutional neural networks (CNN) modeling process with first non-local operations, to generate global parameters; and performing, to the input image, a second CNN modeling process with second non-local operations that are performed with the global parameters, to generate an output image corresponding to the input image.

Also disclosed is a system including a first memory and a chip. The first memory is configured to receive and store an input image. The chip is separated from the first memory, and configured to generate parameters that associated with scaled images associated with non-local information of the input image. Each of the scaled images has a size smaller than a size of the input image. The chip includes a first processing device and a second processing device. The first processing device is configured to downscale the input image, and configured to store the parameters. The chip is further configured to process, by performing first convolutional neural networks (CNN) operations with first non-local operations, the input image being downscaled, to generate the scaled images. The second processing device is configured to receive the parameters from the first processing device and to receive the input image, and configured to generate a portion of an output image based on a portion of the input image and the parameters.

Also disclosed is a method including: downscaling an input image to generate a first scaled image; extracting, from the first scaled image, first parameters associated with global features of the input image; performing a first convolutional neural networks (CNN) operation to a first image block of image blocks in the input image, to generate a second image block; performing a first non-local operation with the first parameters to the second image block to generate a third image block; and generating a portion of an output image corresponding to the input image based on the third image block.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
downscaling an input image to generate a scaled image;
performing, to the scaled image, a first convolutional neural networks (CNN) modeling process with first non-local operations, to generate global parameters; and
performing, to the input image, a second CNN modeling process with second non-local operations that are performed with the global parameters, to generate an output image corresponding to the input image.

2. The method of claim 1, wherein performing the second CNN modeling process with the second non-local operations comprises:
performing first CNN operations and the second non-local operations alternately to generate first intermediate images in order, wherein each of the second non-local operations is performed with a corresponding one of the global parameters to generate a corresponding one of the first intermediate images.

3. The method of claim 2, wherein performing the first CNN modeling process with the first non-local operations comprises:
performing second CNN operations and the first non-local operations alternately to generate second intermediate images in order, wherein each of the second non-local operations is performed with a corresponding one of the global parameters to generate a corresponding one of the second intermediate images; and
generating a next one of the global parameters based on the corresponding one of the second intermediate images.

4. The method of claim 1, further comprising:
dividing the input image into a plurality of first image blocks, wherein the output image include a plurality of second image blocks corresponding to the plurality of first image blocks;
wherein performing the first CNN modeling process with the first non-local operations comprises:
extracting global features of the input image from the scaled image to generate the global parameters; and
wherein performing the second CNN modeling process with the second non-local operations comprise:
applying the global parameters to one of the plurality of first image blocks to generate first intermediate images having the global features; and
generating one of the plurality of second image blocks corresponding to the one of the plurality of first image blocks based on the first intermediate images.

5. The method of claim 1, wherein performing the first CNN modeling process with the first non-local operations comprise:
extracting first global parameters of the global parameters from the scaled image;
transforming the scaled image based on the first global parameters to generate a first one of first intermediate images; and
transforming each one of the first intermediate images based on a corresponding one of the global parameters to generate a next one of the first intermediate images.

6. The method of claim 1, wherein the global parameters include a mean value of the scaled image and a standard deviation of the scaled image.

7. A system, comprising:
a first memory configured to receive and store an input image;
a chip being separated from the first memory, and configured to generate parameters that associated with a plurality of scaled images associated with non-local information of the input image, wherein each of the plurality of scaled images has a size smaller than a size of the input image, the chip comprising:
a first processing device configured to downscale the input image, and configured to store the parameters, wherein the chip is further configured to process, by performing first convolutional neural networks (CNN) operations with first non-local operations, the input image being downscaled, to generate the plurality of scaled images; and
a second processing device configured to receive the parameters from the first processing device and to receive the input image, and configured to generate a portion of an output image based on a portion of the input image and the parameters.

8. The system of claim 7, wherein the first processing device comprises:
a sampling circuit configured to downscale the input image;
a first memory circuit configured to store the plurality of scaled images;
a processing circuit configured to generate the plurality of scaled images and the parameters; and
a second memory circuit configured to store the parameters and configured to transmit the parameters to the second processing device.

9. The system of claim 7, wherein
the first processing device comprises:
a sampling circuit configured to downscale the input image; and
a first memory circuit configured to store the parameters and configured to transmit the parameters to the second processing device; and
the second processing device comprises:
a processing circuit configured to generate the plurality of scaled images and the parameters, and configured to generate the portion of the output image after the parameters are generated; and
a second memory circuit configured to store the plurality of scaled images, and configured to store the portion of the output image after the parameters are generated.

10. The system of claim 7, further comprising:
a second memory being separated from the first memory and the chip, and configured to store the plurality of scaled images and the input image being downscaled wherein the first processing device comprises:
a sampling circuit configured to downscale the input image and transmit the input image being downscaled to the second memory;
a first memory circuit configured to store a part of the plurality of scaled images;
a processing circuit configured to generate the parameters corresponding to the part of the plurality of scaled images; and
a second memory circuit configured to store the parameters and configured to transmit the parameters to the second processing device.

11. The system of claim 7, wherein
the first processing device comprises:
a sampling circuit configured to downscale the input image and transmit the input image being downscaled to the first memory; and
a first memory circuit configured to store the parameters and configured to transmit the parameters to the second processing device; and
the second processing device comprises:
a processing circuit configured to generate the plurality of scaled images and the parameters, and configured to generate the portion of the output image after the parameters are generated; and
a second memory circuit configured to store the portion of the input image, and configured to transmit the input image being downscaled from the first memory to the processing circuit.

12. The system of claim 7, wherein the second processing device is further configured to process the portion of the input image by performing second CNN operations with second non-local operations to generate a plurality of intermediate images,
wherein the second processing device is further configured to generate one of the plurality of intermediate images based on a former one of the plurality of intermediate images and a corresponding one of the parameters.

13. The system of claim 12, wherein the chip is further configured to perform one of the first CNN operations to generate the former one of the plurality of intermediate images, to generate the corresponding one of the parameters.

14. The system of claim 12, wherein one of the first CNN operations and one of the second CNN operations correspond to a same CNN layer.

15. A method, comprising:
downscaling an input image to generate a first scaled image;
extracting, from the first scaled image, first parameters associated with global features of the input image;
performing a first convolutional neural networks (CNN) operation to a first image block of a plurality of image blocks in the input image, to generate a second image block;
performing a first non-local operation with the first parameters to the second image block to generate a third image block; and
generating a portion of an output image corresponding to the input image based on the third image block.

16. The method of claim 15, further comprising:
storing the first parameters in a memory; and
when the third image block is required for the first non-local operation, receiving the first parameters from the memory.

17. The method of claim 15, further comprising:
performing a second CNN operation to the first scaled image to generate a second scaled image; and
performing a second non-local operation with the first parameters to the second scaled image to generate a third scaled image.

18. The method of claim 17, wherein generating the portion of the output image comprises:
extracting, from the third scaled image, second parameters associated with the global features of the input image;
performing a third CNN operation to the third image block to generate a fourth image block; and
performing a third non-local operation with the second parameters to the fourth image block to generate a fifth image block as an input to a next CNN operation.

19. The method of claim 15, wherein performing the first non-local operation comprise:
evaluating one of pixels of the third image block based on pixels of the second image block and the first parameters.

20. The method of claim 19, wherein the first parameters includes a mean value of pixels of the first scaled image and a standard deviation of the pixels of the first scaled image.
